(19) United States
(12) Patent Application Publication
(10) Pub. No.: US 2025/0144578 A1
(43) Pub. Date: May 8, 2025

(54) DILUTION SYSTEM

(71) Applicant: ABILENE CHRISTIAN UNIVERSITY, Abilene, TX (US)

(72) Inventors: Kim Pamplin, Abilene, TX (US); Alli Mae Berry, Abilene, TX (US); Evan Babb, Abilene, TX (US); Ryan Rogers

(21) Appl. No.: 18/501,548

(22) Filed: Nov. 3, 2023

(51) Int. Cl. B01F 23/10; B01F 23/213; B01F 101/23; G01N 1/38

(52) U.S. Cl. CPC B01F 23/19; B01F 23/2132; G01N 1/38; B01F 2101/23; G01N 2001/383

(57) ABSTRACT

Apparatus, systems, and methods for diluting aerosolized high-melting-point solution. A dilution apparatus intakes a flow of aerosolized form of the high-melting-point solution and a flow of inert gas into a continuous multi-chamber volume. The continuous multi-chamber volume comprises an introductory chamber and an expansion chamber that is cross-sectionally larger than the introductory chamber. The dilution apparatus mixes the aerosolized form of the high-melting-point solution with the inert gas in the expansion chamber to dilute the aerosolized form of the high-melting-point solution and channels a portion of the diluted aerosol to a dilution passage.

### TECHNICAL FIELD

The described examples relate generally to systems, devices, and techniques for processing aerosolized high-melting-point solution, and, more particularly, for diluting a molten salt aerosol and reducing flow rate of the diluted aerosol delivered to an analytical instrument.

### BACKGROUND

Molten salt reactors (MSRs) offer an approach to nuclear power that utilizes molten salts as their nuclear fuel in place of the conventional solid fuels used in light water reactors. Advantages include efficient fuel utilization and enhanced safety (largely due to replacing water as a coolant with molten salt). In an MSR, corrosion of metal parts in a molten salt conduit containing a molten salt flow may be caused by various impurities in the molten salt, including in some cases being caused by water (H₂O) and/or oxygen (O₂). Corrosion rates depend on the level(s) of impurities in the molten salt. Accordingly, progress towards a working nuclear reactor that utilizes a high-melting-point solution (e.g., molten salt) must be supported by the ability to identify and quantify potentially corrosive components (e.g., chemical components) in the high-melting-point solution. Analytical instruments, such as atomic absorption spectrometer (AAS) and inductively coupled plasma mass spectrometer (ICP-MS) are commonly used to measure and analyze the molten salt samples. However, such instruments are often subject to plugging, inaccuracies, and/or other deficiencies when the salt is too highly concentrated. In addition, high and/or unstable flow rates of the aerosol may blow out the plasma used in ICP-MS. Further, conventional dilution systems may be overly complex and costly, thereby rendering such options potentially unsuitable or impractical for use in various applications. Therefore, an aerosol dilution system is needed to dilute the molten salt aerosol with an inert gas to reduce the concentration of the aerosol flow going into an analytical instrument and stabilize the flow rate in a streamlined, efficient, and cost-effective manner.

### SUMMARY

In one example, a dilution apparatus is disclosed. The dilution apparatus includes a structural body defining an introductory chamber having a first chamber cross-sectional area. The structural body further defines an expansion chamber extending continuously from the introductory chamber and having a second chamber cross-sectional area that is larger than the first chamber cross-sectional area. The structural body further defines an inert gas port extending into the introductory chamber. The structural body further defines a solution port extending into the introductory chamber. The structural body further defines an exhaust passage having a first passage cross-sectional area fluidly and being coupled to the expansion chamber. The structural body further defines a dilution passage having a second passage cross-sectional area and being fluidly coupled to the expansion chamber. The first passage cross-sectional area is greater than the second passage cross-sectional area.

In another example, the structural body may include a multi-component structure having an introductory chamber body that defines the introductory chamber, and the inert gas port and the solution port extending therein. Further, the structural body may include an expansion chamber body that defines the expansion chamber, and the exhaust passage and the dilution passage extending therefrom.

In another example, the introductory chamber and the expansion chamber may define a continuous multi-chamber volume.

In another example, the expansion chamber may extend from an end of the introductory chamber.

In another example, the expansion chamber and the introductory chamber may each be disposed, concentrically, along a common longitudinal axis of the structural body.

In another example, the structural body may define the inert gas port circumferentially offset from the solution port.

In another example, the structural body may define the inert gas port as longitudinally offset from the solution port.

In another example, the structural body may be configured to withstand a temperature of a solution therein up to 700° C.

In another example, the structural body may further define an exit chamber continuous from the expansion chamber that has a third chamber cross-sectional area that is smaller than the second chamber cross-section area. In this regard, the exhaust passage and the dilution passage may extend from the exit chamber.

In another example, a system is disclosed. The system includes a nebulizer assembly configured to produce an aerosolized form of a high-melting-point solution. The system further includes a dilution apparatus configured to produce a diluted aerosol using the aerosolized form of the high-melting-point solution and an inert gas by (i) introducing a flow of each of the aerosolized form of the high-melting-point solution and a flow of the inert gas into a continuous multi-chamber volume having a progressively larger volume along a longitudinal path of the dilution apparatus to define the diluted aerosol therein, and (ii) channeling a portion of the diluted aerosol of the continuous multi-chamber volume to a dilution passage. The system further includes instrumentation, fluidly coupled to the dilution passage, that is configured to determine chemical contents of the diluted aerosol.

In another example, the instrumentation may include an inductively coupled plasma mass spectrometer (ICP-MS) and an inductively coupled plasma optical emission spectrometer (ICP-OES).

In another example, the dilution apparatus may channel the diluted aerosol to the instrumentation at a rate of at least 1.0 liter/minute and may have a concentration of mass per unit time of electrolyte within the range of 0˜0.15 mg/min.

In another example, the dilution apparatus may include a structural body defining the multi-chamber volume. The multi-chamber volume may include an introductory chamber at an entrance of each of the flows and have a first size. The multi-chamber volume may further include an expansion chamber extending continuously from the introductory chamber and have a second size that is greater than the first size. The structural chamber may define an exhaust passage extending from the expansion chamber. The exhaust passage may have a size that is substantially greater than a size of the dilution passage.

In another example, a method of analyzing a molten salt solution is disclosed. The method includes producing an aerosolized form of a high-melting-point solution using a nebulizer assembly. The method further includes producing a diluted aerosol from the aerosolized form of the high-melting-point solution using a dilution apparatus. In this regard, the producing further includes introducing a flow of each of the aerosolized form of the high-melting-point solution and a flow of the inert gas into a continuous multi-chamber volume having a progressively larger volume along a longitudinal path of each of the through the dilution apparatus to define the diluted aerosol therein. Further, the producing includes channeling a portion of the diluted aerosol of the continuous multi-chamber volume to a dilution passage. The method further includes determining chemical contents of the diluted aerosol using instrumentation fluidly coupled to the dilution passage.

In another example, the diluted aerosol may have a concentration of mass per unit time of electrolyte in the dilution passage. In this regard, the method may further include controlling the concentration of mass per unit time of electrolyte to within a range of 0˜0.15 mg/min by adjusting a flow rate of each of the flows of the aerosolized form of the high-melting-point solution and the inert gas.

In another example, the diluted aerosol may have a flow rate per unit time in the dilution passage. In this regard, the method may further include controlling the flow rate per unit time to at least 1.0 liter/minute by adjusting a flow rate of each of the flows of the aerosolized form of the high-melting-point solution and the inert gas.

In another example, the continuous multi-chamber volume may include an introductory chamber and an expansion chamber that is cross-sectionally larger than the introductory chamber. In this regard, the introducing may include forcing each of the flows of the aerosolized form of the high-melting-point solution and the inert gas sequentially through the introductory chamber, and then the expansion chamber.

In another example, the method may further include causing an exit of a balance of the diluted aerosol not channeled through the dilution passage through an exhaust passage. Accordingly, the exhaust passage may have a size that is great than a size of the dilution passage.

In addition to the example aspects described above, further aspects and examples will become apparent by reference to the drawings and by study of the following description.

### BRIEF DESCRIPTION OF THE DRAWINGS

FIG. 1A depicts a schematic diagram of a system for identifying and quantifying components in a high-melting-point solution, including a dilution apparatus.

FIG. 1B depicts a schematic diagram of the dilution apparatus of FIG. 1A in a system for identifying and quantifying components in a high-melting-point solution.

FIG. 2 depicts a schematic diagram of another example dilution apparatus.

FIG. 3 depicts a table listing a plurality of configuration parameters in a dilution apparatus.

FIG. 4A depicts a schematic diagram of another example dilution apparatus.

FIG. 4B depicts a schematic diagram of another example dilution apparatus.

FIG. 5 depicts a schematic diagram of another example dilution apparatus.

FIG. 6 depicts a schematic diagram of another example dilution apparatus.

FIG. 7 depicts a schematic diagram of another example dilution apparatus.

FIG. 8A depicts a detailed view of a Y splitter of FIG. 7

FIG. 8B depicts a detailed view of another Y splitter of FIG. 7.

FIG. 9 depicts a flow diagram of an example dilution process in a molten salt reactor system.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The description that follows includes sample systems, methods, and apparatuses that embody various elements of the present disclosure. However, it should be understood that the described disclosure may be practiced in a variety of forms in addition to those described herein.

The following disclosure relates generally to a dilution apparatus and system for diluting molten salt aerosol solution and controlling aerosol flow rate. The dilution apparatus may be used with molten salt nuclear reactors or MSRs; however, it will be appreciated that the dilution apparatus of the present disclosure may be used in a variety of systems for which dilution of a aerosol is desired. With reference to the application of the dilution apparatus with an MSR, such MSR may broadly include a collection of components configured to circulate a molten fuel salt along a fuel salt loop. For example, a molten salt reactor system may operate by circulating a molten fuel salt between a reactor vessel (within which fission occurs) and a heat exchanger (for the removal of heat from the fuel salt). Upon shutdown of the molten salt reactor system, it may be necessary to remove the molten fuel salt from the fuel salt loop, such as removing the fuel salt from the reactor vessel, heat exchanger and other associated components of the system. In this regard, example molten salt reactor systems may include a drain tank or other vessel or receptacle elevationally below the fuel salt loop that is configured for receive a gravitational flow of the fuel salt upon shutdown. It may be desirable to measure the molten salt samples of the system for various properties, including measuring a composition of the salt. In this regard, various analytical instruments may be used to conduct such tests, including, without limitation, an atomic absorption spectrometer (AAS) and inductively coupled plasma mass spectrometer (ICP-MS). In some cases, the molten salt may be nebulized or otherwise transformed into an aerosolized form prior to introduction into these or other instruments. In many cases, however, the aerosolized molten salt solution can remain too highly concentrated for proper analysis by the instruments. Further, such aerosolized molten salt solution can have an uneven or unstable flow, which may further hinder the operation of such instruments.

To mitigate these and other deficiencies, the molten salt dilution apparatus disclosed herein may be configured to receive a supply of the aerosolized form of the molten salt solution and dilute the solution to a concentration appropriate for analysis by the analytical instruments. Further, the molten salt dilution apparatus may be further configured to reduce the flow of the molten salt solution to an acceptable level, such as to a level that is tailored to the instrumentation. In this regard, and as described in greater detail below, the dilution apparatus may include a multi-chamber volume that is configured to receive a flow of the aerosolized molten salt solution and a flow of an inert gas. Broadly, the multi-chamber volume may include a series of adjacent chambers, each having a progressively larger volume. Upon entry into the multi-chamber volume of the dilution apparatus, the aerosolized molten salt solution and the inert gas flow may mix with one another in order to reduce the concentration of the molten salt therein. For example, the aerosolized molten salt solution and the inert gas may each flow through the multi-chamber volume and into the progressively larger volume to facilitate mixing, and optionally turbulent flow therebetween. The dilution apparatus may further include at least a first exit for the diluted aerosol to various analytical instruments, and a second exit for dumping the balance of the diluted aerosol to an exhaust or vent. The dilution apparatus may therefore be tailored to deliver a desired quantity of the diluted aerosol to the analytical instrumentation, which may be calibrated to the particular type and specifications of the instruments being used. Accordingly, the dilution apparatus of the present disclosure may be specifically adapted to both dilute the aerosolized molten salt flow to a concentration appropriate for any of a variety of analytical instruments, and to reduce and stabilize for the rate of flow of the diluted form of the aerosolized molten solution for said instruments.

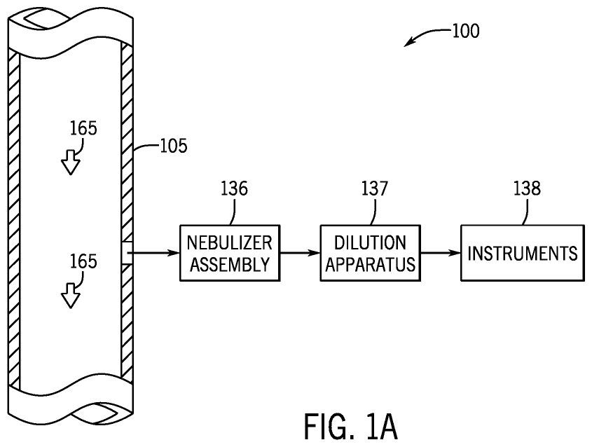

Turning to the Drawings, with reference to FIG. 1A, a schematic diagram of a system 100 for identifying and quantifying components in a high-melting-point solution is shown. The system 100 includes a molten liquid conduit 105, a nebulizer assembly 136, a dilution apparatus 137, and instrument(s) 138. The molten liquid conduit 105 is configured to contain a high-melting-point solution 165, as in FIG. 1A, and, in some embodiments, forms part of a molten salt loop associated with a nuclear reactor. The nebulizer assembly 136 is configured to receive a volume of the high-melting-point solution 165 from the molten liquid conduit 105. The received volume of the high-melting-point solution 165 is then aerosolized by the nebulizer assembly 136, as will be described in further detail below. The dilution apparatus 137 is configured to receive the aerosolized portion of the high-melting-point solution 165, also called aerosol solution, from the nebulizer assembly 136 and dilute the aerosolized portion of the high-melting-point solution 165 to a predetermined ratio. The instrument(s) 138 are configured to receive the diluted aerosolized portion of the high-melting-point solution 165 from the dilution apparatus 137. The instrument(s) 138 may be or include a variety of analytical instrumentation configured to receive the diluted aerosolized volume of the high-melting-point solution 165 from the dilution apparatus 137 and to determine the chemical contents of the diluted aerosolized high-melting-point solution 165, as will be described in further detail below.

Referring to FIG. 1B, with continuing reference to FIG. 1A, the nebulizer assembly 136 is shown associated with an inert gas source 110, a mass flow controller (MFC) 120, a nebulizer 130, a kiln 140, and an adapter 150. As described in FIG. 1A, the molten liquid conduit 105 is configured to contain the high-melting-point solution 165, and, in some embodiments, forms part of a molten salt loop associated with a nuclear reactor. The nebulizer assembly 136 is configured to receive the high-melting-point solution 165 from the molten liquid conduit 105. In some examples, the nebulizer assembly 136 is configured to receive the high-melting-point solution 165 from the molten liquid conduit 105 via a pump or a valve (not shown). The pump or the valve may be actuable to control flow of the high-melting-point solution 165 from the molten liquid conduit 105 to the nebulizer assembly 136.

As shown in the FIG. 1B, the MFC 120 is operatively connected to an inert gas source 110 and configured to receive inert gas (e.g., argon or nitrogen) from the gas source 110. The MFC 120 controls flow of the gas delivered to the nebulizer 130 at a particular range of flow rates. The nebulizer 130 is contained within the kiln 140. The nebulizer 130 is configured to mix the gas with the high-melting-point solution 165 and aerosolize the mixture. The aerosolized volume of the high-melting-point solution 165 is then delivered to the dilution apparatus 137 via the adapter 150. In one embodiment, the adapter 150 includes a Y splitter, as will be described in further detail below, to control the flow rate of aerosolized volume of the high-melting-point solution 165 delivered to the dilution apparatus 137.

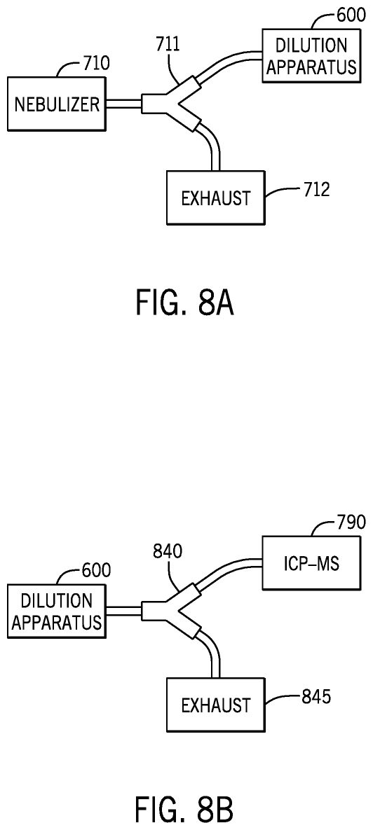

Referring still to FIG. 1B, in an example, the dilution apparatus 137 is shown operatively connected to an inert gas source 111 via an MFC 121. The MFC 121 controls flow of the inert gas (e.g., argon or nitrogen) from the gas source 111 to the dilution apparatus 137 at a particular range of flow rates. The dilution apparatus 137 receives the gas from the gas source 111 and mixes it with the aerosolized volume of the high-melting-point solution 165 to dilute the aerosol to a target ratio. The diluted aerosolized volume of the high-melting-point solution 165 is later delivered to the instrument(s) 138 for measurement and analysis. In one embodiment, the instrument(s) 138 include a flame atomic absorption spectrometer (FAAS) configured to identify and quantify element(s) in the aerosolized volume of the high-melting-point solution 165. In one or more embodiments, as in FIG. 1B, the instrument(s) 138 also include an ICP-MS 139 configured to identify and quantify element(s) in the aerosolized volume of the high-melting-point solution 165. As in FIG. 1B, dilution apparatus 137 connects the instrument(s) 138 via a flow restrictor/valve 122 and an adapter 151 that are configured to control the flow of the diluted aerosolized volume of the high-melting-point solution 165 at a desired flow rate. For example, the desired flow rate delivered to the ICP-MS 139 is set to 0.96 L/min; however it will be appreciated that the flow rate delivered to the ICP-MS 139 may be higher or lower, including in some cases being substantially higher or lower, including being within a range of appropriately 0˜1 L/min. In one example, the adapter 151 includes a Y splitter, as will be described in further detail below with references to FIGS. 8A and 8B herein, to control the flow rate of diluted aerosolized volume of the high-melting-point solution 165 delivered to the instrument(s) 138.

The dilution apparatus 137 is also operatively connected to an exhaust system 160 through a flow restrictor/valve 123 to process unwanted volume of the aerosolized high-melting-point solution 165, so that the aerosolized high-melting-point solution 165 delivered to the instrument(s) 138 is maintained at a desired flow rate.

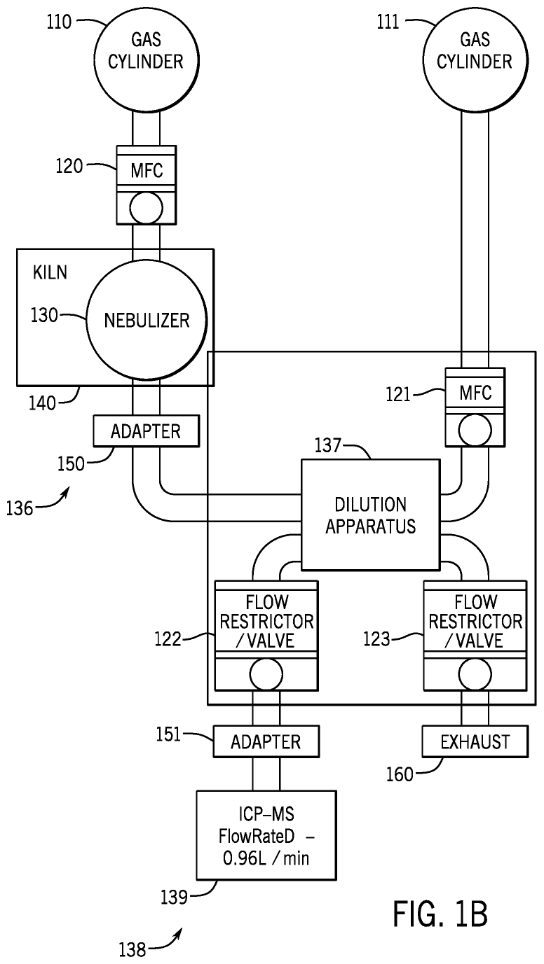

Referring to FIG. 2, a schematic diagram of a dilution apparatus 200 is shown. The dilution apparatus 200 may be substantially analogous to the dilution apparatus 137 and be configured to receive a supply of inert gas in 240 and a supply of concentrated solution in 250, and, in turn, provide a diluted form of the (aerosolized) solution to a diluted aerosol out 260, while exiting the balance of the solution at exhaust out 270. To facilitate the foregoing functionality, the dilution apparatus 200 is shown as including a multi-chamber volume 210. The multi-chamber volume 210 may generally include a series of internal chambers, with each chamber having a different diameter or cross-dimension than an adjacent chamber. The multi-chamber volume 210 is operatively connected to an inert gas source (e.g., argon or nitrogen) 240 and a nebulizer 250. The multi-chamber volume 210 intakes inert gas from the gas source 240 to dilute the high-melting-point solution aerosol provided by the nebulizer 250. For example, and as described in greater detail herein, the multi-chamber volume 210 may include at least two adjacently arranged chambers having a progressively larger diameter, and thus great volume, along a longitudinal path of the solution through the dilution apparatus 200. In this regard, the inert gas in 260 and the concentrated solution in 250 may initially enter the multi-chamber volume 210 at a chamber having a first smaller size, and then proceed to a second chamber having a second, larger size. The progression of the solution in this manner into the second, larger-sized chamber may promote mixing, and in some cases, turbulent flow, that encourages the concentrated solution in 250 to mix with, and be diluted by, the inert gas in 240. In some cases, the multi-chamber volume 210 may include three, four, or more adjacent chamber of various diameters and volumes to promote dilution.

In any case, the multi-chamber volume 210 may direct the fluid contained therein to a first exit passage 220 and a second exit passage 230, as shown schematically in the example of FIG. 2. The first exit passage 220 and the second exit passage 230 may cooperate to cut or select a defined portion of the diluted aerosol from the multi-chamber volume 210 to the diluted aerosol out 260 for analysis by one or more instruments connected thereto. The first and second exit passages 220, 230 may therefore serve to reduce the overall flow or volume of the diluted aerosol that ultimately reaches the instruments, which may promote overall accuracy and precision of measurements. The remainder of the diluted aerosol of the multi-chamber volume 210 may, in turn, be dumped to the second exit passage 230 which flows to exhaust out 270 and/or other flow path that routes the remainder of the diluted aerosol to a waste receptacle or vent, as appropriate.

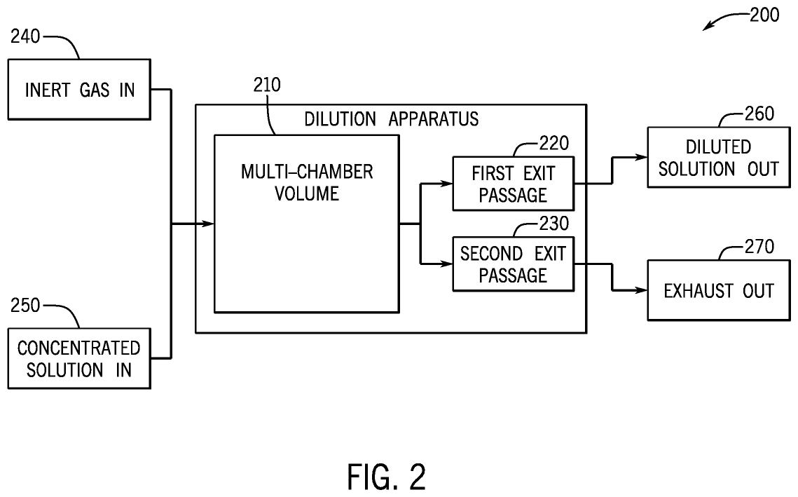

FIG. 3 lists a plurality of dilution ratios to achieve a desired concentration of mass per unit time of electrolyte. For example, the desired concentration is set to 0.1236 mg/min. When the aerosol flow rate leaving the nebulizer to enter the dilution system is 0.379 mg/min, the needed dilution air flow rate is 1.15 mg/min and the desired dilution ratio is set to 3.05. In another example, when the aerosol flow rate leaving the nebulizer to enter the dilution system is 0.756 mg/min, the needed dilution air flow rate is 6.10 mg/min and the desired dilution ratio is set to 6.1. In another example, when the aerosol flow rate leaving the nebulizer to enter the dilution system is 1.13 mg/min, the needed dilution air flow rate is 10.4 mg/min and the desired dilution ratio is set to 9.17. In another example, when the aerosol flow rate leaving the nebulizer to enter the dilution system is 1.51 mg/min, the needed dilution air flow rate is 18.4 mg/min and the desired dilution ratio is set to 12.2. In another example, when the aerosol flow rate leaving the nebulizer to enter the dilution system is 1.89 mg/min, the needed dilution air flow rate is 28.8 mg/min and the desired dilution ratio is set to 15.2.

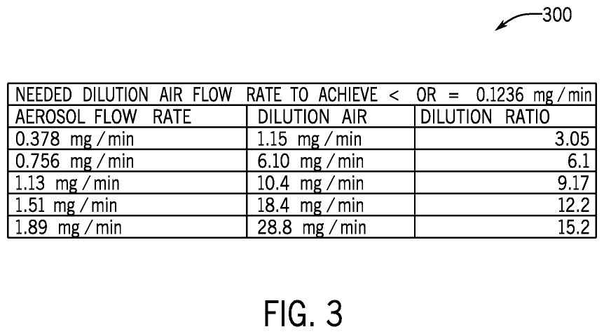

FIG. 4A illustrates another example dilution apparatus 400. The dilution apparatus 400 may be substantially analogous to the dilution apparatus 137, 200 described above in relation to FIGS. 1A-2. The dilution apparatus 400 may include a structural body 402. The structural body 402 may be formed from any of a variety of materials that may be configured to withstand the temperatures and corrosivity of the molten salt solutions held therein. For example, in some cases, the structural body 402 may be formed from a stainless steel material capable of withstanding temperatures in excess of 500° C., such being capable of withstanding temperatures in excess of 600° C., or such as being capable of withstanding temperature in excess of 700° C., or greater. The structural body 402, as shown in FIG. 4A, may be a multi-piece structure that includes at least an introductory chamber body 404a, an expansion chamber body 404b, a first end cap 406a, a second end cap 406b, and one or more connecting pieces (connecting piece 408). In other cases, more or fewer components may be used, including in some examples in which the structural body may generally be defined as a unitary or one-piece structure.

The structural body 402 may generally define a multi-chamber volume 401 and a plurality of inlet and outlets leading to and from, respectively, the multi-chamber volume 401. The multi-chamber volume 401 may generally be composed of a series of adjacent chambers, each having a different cross-section (and diameter). In one example, the multi-chamber volume 401 may include or define at least an introductory chamber 410 and an expansion chamber 412. The introductory chamber 410 may generally be an adjacent and smaller-diameter chamber as compared with the expansion chamber 412. For example, the introductory chamber 410 may have a diameter of around 3.5 inches whereas the expansion chamber 412 may have a diameter of around 4.5 inches. It will be appreciated, however, that in other examples, other dimensions may be possible in which the introductory chamber 410 has a smaller diameter than the expansion chamber 412.

The introductory chamber 410 may be configured to receive a flow of solutions therein (as described in greater detail below) and introduce such solutions into the expansion chamber 412. The expansion chamber 412 may be larger than the introductory chamber 410 in order to promote turbulent flow and mixing therein. In the example of FIG. 4A, the introductory chamber 410 is shown as being defined generally by the introductory chamber body 404a and the first end cap 406a, and the expansion chamber 412 is shown as being defined generally by the expansion chamber body 404b and the second end cap 406b. In the multi-component structure assembly of the structural body 402, the introductory chamber 410 and the expansion chamber 412 may be coupled to one another via a connecting piece 408. The connecting piece 408 may be a steel plate that may define a shoulder or transition between the introductory chamber body 404a and the expansion chamber body 404b. In some cases, the connecting piece 408 may define a welded connection between the introductory chamber body 404a, and the expansion chamber body 404b to define a permanent, leak-tight seal therebetween. To facilitate the foregoing, the connecting piece 408 may have a thickness of around 0.25 inches, and/or other thickness as appropriate to form a welded and/or threaded connection therebetween.

The structural body 402 may further define a series or ports, passages, inlets, and outlets into and out from the multi-chamber volume 401 in order to facilitate the various functionalities described herein. For example, the structural body 402 may define a solution port 420 leading into the multi-chamber volume 401, such as having the introductory chamber body 404a define the solution port 420 as leading into the introductory chamber 410. Further, the structural body 402 may define an inert gas port 425 leading into the multi-chamber volume 401, such as having the introductory chamber body 404a further define the inert gas port 425 as leading into the introductory chamber. In the sample illustration of FIG. 4A, both the solution port 420 and the inert gas port 425 may have a diameter of around 0.5 inches; however, in other cases, other diameters of the ports are contemplated herein, and as may be tailored for a needed flow rate of the inert gas and solution into the introductory chamber 410. Further, the structural body 402 may define an exhaust passage 430 extending from the multi-chamber volume 401, such as having the expansion chamber body 404b define the exhaust passage 430 as extending from the expansion chamber 412. Further, the structural body 402 may define a dilution passage 440 extending from the multi-chamber volume 401, such as having the expansion chamber body 404b and the second end cap 406b further define the dilution passage 440 as extending from the expansion chamber 412. In the example illustration of FIG. 4A, the dilution passage 440 may have a diameter of around 0.375 inches and the exhaust passage 430 may have a diameter of around 1.05 inches; however, in other cases, other diameters of the passages are contemplated herein, and as may be tailored for a needed flow rate of the dilution form of the aerosolized flow out of the dilution passage 430. As such, the dilution passage 440 may have a diameter that is less than a diameter of the exhaust passage 430 in order to facilitate having a select portion of the diluted aerosol progress to the analytical instrumentation (e.g., via the dilution passage 440), while the balance of such solution is dumped to the exhaust passage 430.

In operation, and as discussed in FIG. 2, aerosolized volume of high-melting-point solution (e.g., molten salt) enters the introductory chamber 410 through the aerosol solution port 420 and inert gas (e.g., argon or nitrogen) enters the introductory chamber 410 through the inert gas port 425. Referring still to FIG. 4A, the expansion chamber 412 extends from an end of the introductory chamber 410 and both chambers are disposed concentrically along a common longitudinal axis. The expansion chamber 412 mixes the aerosolized volume of high-melting-point solution (e.g., molten salt) with the inert gas (e.g., argon or nitrogen) and dilutes the aerosol solution (e.g., molten salt aerosol) with a desired dilution ratio, wherein the desired dilution ratio is calculated based on the input aerosol flow rate from the aerosol solution port 420 and a desired flow rate emitted from the expansion chamber 412. The diluted aerosol solution is then emitted through the exhaust passage 430 and the dilution passage 440.

FIG. 4B illustrates another example dilution apparatus 400′. The dilution apparatus 400′ may be substantially analogous to the dilution apparatus 400 described above in relation to FIG. 4A, except that the solution port 420 and the inert gas port 425 as being longitudinally offset from one another relative to a longitudinal axis 480 of the multi-chamber volume 401. As illustrated in FIG. 4B, the solution port 420 may extend into the introductory chamber 410 at a first point 452 along the longitudinal axis 480 (e.g., such as a point that is closer to the end cap 406a than to the expansion chamber 412). Further, the inert gas port 425 may extend into the introductory chamber 410 at a second point 454 along the longitudinal axis 680 (e.g., such as point that is generally between the first point and the expansion chamber 412). In this regard, the aerosolized solution may enter the introductory chamber 410 initially undisturbed by any inert gas flow from the inert gas port 425. Subsequently, as the solution proceeds through the introductory chamber 410 and along the longitudinal axis 480, it may encounter the inert gas generally at the second point 454. The introduction of the inert gas at the second point 454 while the solution is already in the introductory chamber 410 may promote mixing of the inert gas and the solution in the introductory chamber 410 in preparation for further mixing and dilution in the expansion chamber 412, as described herein. Additionally or alternatively, the solution port 420 and the inert gas port 425 may be circumferentially offset from one another. For example, the introductory chamber body 404a may be defined by a pipe or other tubing having an outer circumference. In some cases, the solution port 420 and the inert gas port 425 may enter the introductory chamber 410 at different, off-set points about said outer circumference, which, in some cases, may further promote mixing of the aerosolized solution and the inert gas.

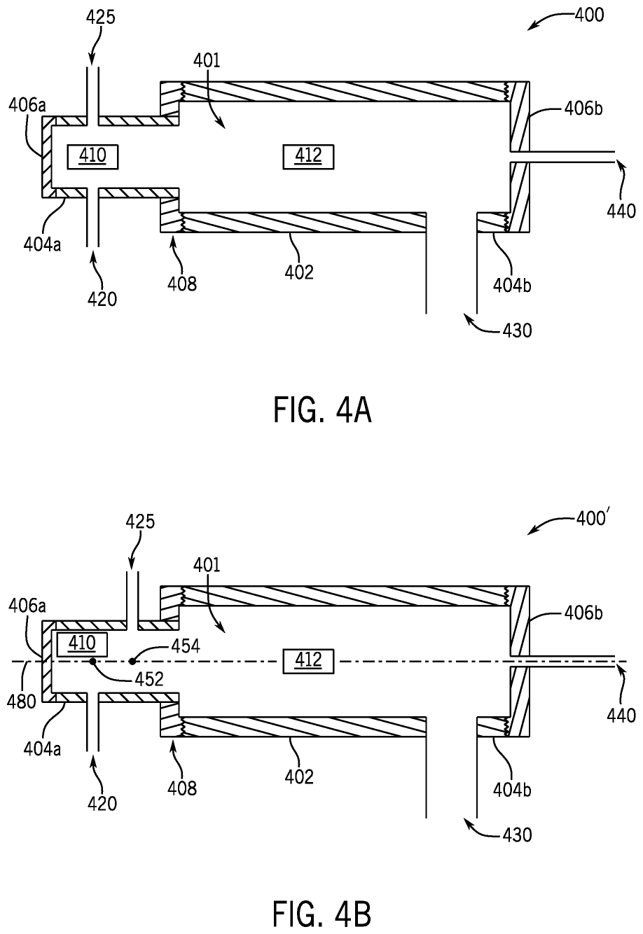

FIG. 5 illustrates another example dilution apparatus, a dilution apparatus 500. The dilution apparatus 500 may be substantially analogous to the dilution apparatus 400 described above in relation to FIG. 4A. In this regard, the dilution apparatus 500 is shown in FIG. 5 as including a structural body 502, an introductory chamber body 504a, an expansion chamber body 504b, end caps 506a, 506b, a multi-chamber volume 501, an introductory chamber 510, an expansion chamber 512, a connecting piece 508, an inert gas port 525, a solution port 520, an exhaust passage 530, a dilution passage 540; redundant explanation of which are omitted for clarity.

Notwithstanding the foregoing similarities, the dilution apparatus 500 is shown as including an additional chamber within the multi-chamber volume 501. For example, FIG. 5 shows the dilution apparatus 500 as including the introductory chamber 510, the expansion chamber 512, and additionally an exit chamber 514. For example, the structural body 502 of FIG. 5 may be a multi-component structure including the introductory chamber body 504a, the expansion chamber body 504b, and additionally an exit chamber body 504c. The exit chamber body 504c may generally define the exit chamber 514 within the multi-chamber volume 501 and be connected, adjacently to the expansion chamber body 504b. In some cases, as shown in FIG. 5, the exit chamber body 504c may be coupled to the expansion chamber body 504b via a second connecting piece 509. Accordingly, and as shown in FIG. 5, the structural body 502 may be a multi-component structure including each of the introductory chamber body 504a, the expansion chamber body 504b, the exit chamber body 504c, the connecting pieces 508, 509, and the end caps 506a, 506b. However, it will be appreciated that in some cases, one or more or all of the components of the structural body 502 may be formed as an integral or one-piece structure, as needed for a given application.

The introductory chamber 510, the expansion chamber 512, and the exit chamber 514 may be arranged in series such that solution and inert gas introduces into the multi-chamber volume 501 generally progressing serially through each respective chamber. As described above in relation to FIG. 4A, the aerosolized solution may enter the introductory chamber 510 at the solution port 520, and the inert gas may enter the introductory chamber 510 at the inert gas port 525. The mixture of aerosolized solution and inert gas may proceed from the introductory chamber 510 and the expansion chamber 512, as described herein, and into the exit chamber 514. From the exit chamber 514, the diluted form of the aerosolized solution may exit the multi-chamber volume 501 at either the dilution passage 540 or the exhaust passage 530. For example, in the dilution apparatus 500 of FIG. 5, the dilution passage 540 may be defined by the exit chamber body 504c and/or the end cap 506b. Further, the exhaust passage 540 may be defined by the exit chamber body 504c and/or the end cap 506b. The diluted form of the aerosolized solution may therefore exit the multi-chamber volume 501 at the desired quantities described herein. In some cases, by adding the exit chamber 514 serially in line with the expansion chamber 512, the exit chamber 514 may be operated to establish a more laminar, steady (or at least less turbulent) flow of the diluted aerosol, which, in turn, may allow the dilution passage 540 to receive a more predictable flow and concentration of aerosolized molten salt for delivering for any analytical instruments connected thereto.

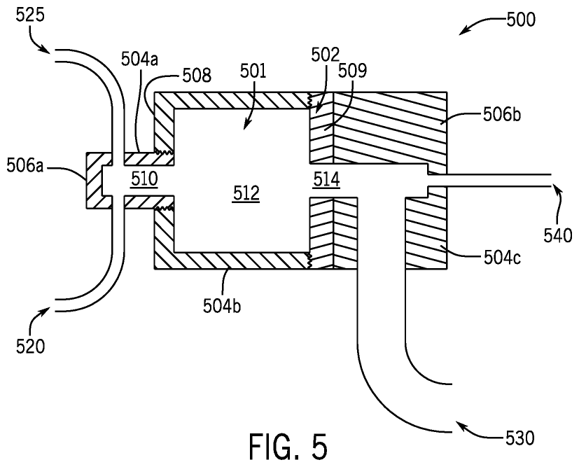

With reference to FIG. 6, another example dilution apparatus is shown, a dilution apparatus 600. The dilution apparatus 600 may be substantially analogous to the dilution apparatus 500 described above in relation to FIG. 5. In this regard, the dilution apparatus 600 is shown in FIG. 6 as including, a structural body 602, an introductory chamber body 604a, an expansion chamber body 604b, an exit chamber body 604c, end caps 606a, 606b, a multi-chamber volume 601, an introductory chamber 610, an expansion chamber 612, an exit chamber 614, a connecting piece 608, a second connecting piece 609, an inert gas port 625, a solution port 620, an exhaust passage 630, a dilution passage 640; redundant explanation of which are omitted for clarity.

Notwithstanding the foregoing similarities, the dilution apparatus 600 is shown in FIG. 6 as having the solution port 620 and the inert gas port 625 as being longitudinally offset from one another relative to a longitudinal axis 680 of the multi-chamber volume 601. For example, the solution port 620 may extend into the introductory chamber 610 at a first point 652 along the longitudinal axis 680 (e.g., such as a point that is closer to the end cap 606a than to the expansion chamber 612). Further, the inert gas port 625 may extend into the introductory chamber 610 at a second point 654 along the longitudinal axis 680 (e.g., such as point that is generally between the first point and the expansion chamber 612). In this regard, the aerosolized solution may enter the introductory chamber 610 initially undisturbed by any inert gas flow from the inert gas port 625. Subsequently, as the solution proceeds through the introductory chamber 610 and along the longitudinal axis 680, it may encounter the inert gas generally at the second point 654. The introduction of the inert gas at the second point 654 while the solution is already in the introductory chamber 610 may promote mixing of the inert gas and the solution in the introductory chamber 610 in preparation for further mixing and dilution in the expansion chamber 612, as described herein. Additionally or alternatively, the solution port 620 and the inert gas port 625 may be circumferentially offset from one another. For example, the introductory chamber body 604a may be defined by a pipe or other tubing having an outer circumference. In some cases, the solution port 620 and the inert gas port 625 may enter the introductory chamber 610 at different, off-set points about said outer circumference, which, in some cases, may further promote mixing of the aerosolized solution and the inert gas.

While may constructions and dimension of the of the various components of the dilution apparatus 600 are possible, for purposes of illustration, a diameter of the expansion chamber 612 may be around 4 inches, and may have a length of around 8 inches. Further, a diameter of the introductory chamber 610 may be around 3 inches, and may have a length of around 3 inches. Further, the solution port 620 may have a diameter of around 0.38-inches, and the inert gas port 625 may have a diameter of around 0.5 inches. Further, the exhaust passage 630 may have a diameter of around 2 inches, and a length extending from the expansion chamber body 604b of around 2.5 inches. Further, the dilution passage 640 may have a diameter of around 0.38 inches, and a length extending from the end cap 606b of around 3.0 inches. It will be appreciated that the foregoing dimensions are presented for purposes of example; in other cases, other dimensions may be used. For example, one or more of the dimensions may be tuned or calibrated in order to deliver a desired flow rate and concentration of molten salt to the analytical instrumentation connected thereto.

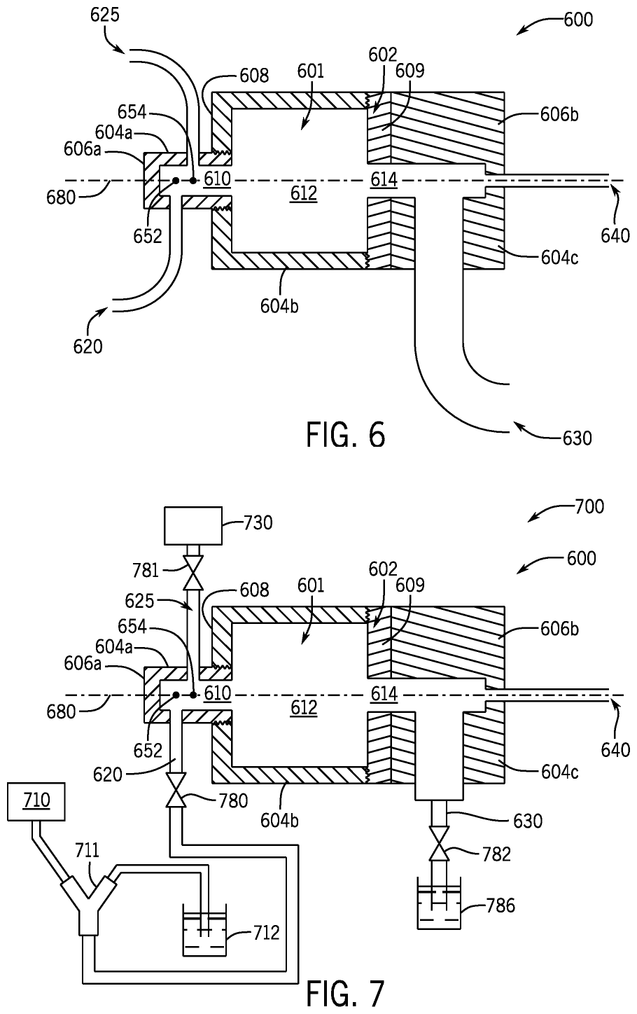

With reference to FIG. 7, the dilution apparatus 600 of FIG. 6 is shown in the context of a dilution system 700. The dilution system 700 may include the dilution apparatus 600, a nebulizer 710, a Y splitter 711, water source 712, an inert gas source 730, instrumentation 790 (shown in FIG. 8B), and a dump tank 786. In operation, the nebulizer 710 may heat the high-melting-point solution and produce an aerosol form of such solution. The nebulizer 710 may, in turn, transmit the aerosol solution to the introductory chamber 610 through the aerosol solution port 620 with a predefined flow rate based, in part, on the dimension and configurations of the Y splitter 711. Further, the gas source 730 may transmit the inert gas (e.g., argon or nitrogen) into the introductory chamber 610 through the inert gas port 625. The aerosol solution and the inert gas are mixed in the expansion chamber 612. The dilution apparatus 600 may further be configured to control the aerosol solution port 620, the inert gas port 625, dilution passage 640, and the exhaust passage 630 to achieve a desired dilution ratio and maintain a low constant flow rate (e.g., less or equal to 2000 ppm) of the diluted aerosol solution delivered to the ICP-MS 790. For example, the dilution apparatus 700 may include or be associated with certain control valves or devices at each of the of the solution port 620, the inert gas port 625, the exhaust passage 630, and the dilution passage 640, which may be further used to control or throttle a flow of any of the aerosolized solution, the inert gas, and the diluted forms of the same for achieving the desired flow rate and contractions of the solution to the instruments. By way of example, FIG. 7 shows a first control valve 780 as being associated with the solution port 620, a second control valve 781 as being associated with the inert gas port 625, a third control valve 782 as being associated with the exhaust passage 630, and a Y splitter 711 as being associated with the dilution passage 640. In an alternative example, the Y splitter 711 associated with the dilution passage 640 can be replaced by a control valve. In some cases, one or more of the control valves 780-782 and Y splitter 711 may be omitted. Where implemented, the control valves 780-782 and Y splitter 711 may be operated to define a flow into and/or out of the multi-chamber volume 501, such as defining any of such flows as listed in FIG. 3 herein.

Referring to FIG. 8A, a detail view of the Y splitter 711 is shown. In operation, the nebulizer 710 may send aerosol solution to the dilution apparatus 600 through the Y splitter 711, where the Y splitter 711 is used to control the flow rate of the aerosol solution delivered to the dilution apparatus 600 by releasing unwanted aerosol solution into an exhaust of dump tank 712. Additionally or alternatively, in another example, as illustrated in the detailed view of FIG. 8B, the dilution apparatus 600 may deliver the diluted aerosol solution to the instrumentation 790 (e.g., ICP-MS and/or other instrumentation) through a Y splitter 840. The Y splitter 840 may be configured to control the flow rate of the diluted aerosol solution delivered to the instrumentation 790 by releasing unwanted aerosol solution into an exhaust or dump tank 845.

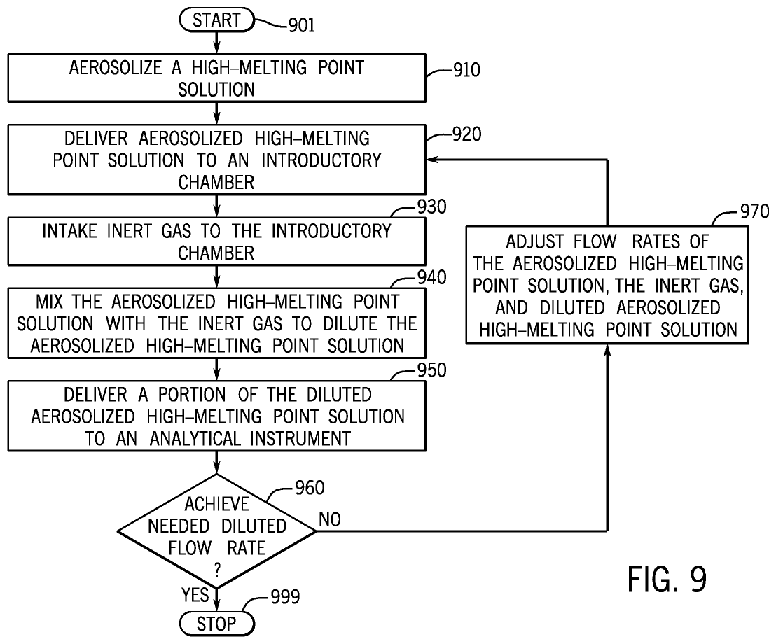

FIG. 9 depicts a flow diagram of an exemplary dilution process 900 in a molten salt reactor system. The dilution process starts with 901. At step 910, a nebulizer assembly heats and aerosolizes a volume of high-melting-point solution (e.g., molten salt). The aerosolization process can occur in a kiln or a heat chamber. An exemplary melting point is between 190° C. and 200° C. Some exemplary molten salt includes nitrate salt mixture such as LiNO₃, KNO₃, CaNO₃, and NaNO₃.

At step 920, the nebulizer delivers the aerosolized volume of high-melting-point solution, also called aerosol solution, to a dilution apparatus, wherein the dilution apparatus includes a multi-chamber volume. The multi-chamber volume comprises at least one introductory chamber and one expansion chamber. The expansion chamber extends from an end of the introductory chamber and has a larger cross-sectional area than the introductory chamber. An aerosol solution port is disposed on the introductory chamber to intake the aerosolized volume of high-melting-point solution. In an alternative embodiment, the multi-chamber volume further defines an exit chamber continuous from the expansion chamber and the exit chamber's cross-sectional area is smaller than the expansion chamber's cross-section area. In one embodiment, the nebulizer can deliver the aerosolized volume of high-melting-point solution, also called aerosol solution, to the introductory chamber of the dilution apparatus through a Y splitter.

At step 930, an inert gas source delivers a volume of inert gas (e.g., argon or nitrogen) to the introductory chamber of the dilution apparatus. The inert gas is used to dilute the aerosolized volume of high-melting-point solution. An inert gas port is disposed on the introductory chamber to intake the inert gas, wherein the inert gas port is disposed after the aerosol solution port with a circumferentially offset and a longitudinally offset, as illustrated in FIG. 6.

At step 940, the dilution apparatus mixes the aerosolized volume of high-melting-point solution mixes with the inert gas in the expansion chamber to dilute the aerosolized volume of high-melting-point solution.

At step 950, the dilution apparatus delivers, via a dilution passage, a portion of the diluted aerosol solution to an analytical instrument, such as an ICP-MS, for particle measurement and analysis. In one embodiment, an exhaust passage is disposed on the expansion chamber to release unwanted diluted aerosol solution. The dilution passage is disposed on a steel plate welded to the expansion chamber. In another embodiment, the exhaust passage is disposed on an exit chamber to release unwanted diluted aerosol solution and the dilution passage is disposed on a steel plate welded to the exit chamber. The exhaust passage has a larger cross-sectional area than that of the dilution passage.

At step 960, the analytical instrument, such as the ICP-MS, measures and analyzes the diluted aerosol solution, and determines if a needed diluted flow rate is achieved. If yes, the dilution process 900 proceeds to step 999 and stops. Otherwise, the dilution process 900 proceeds to step 970.

At step 970, the dilution apparatus adjusts at least one of the aerosol solution port, the inert gas port, the dilution passage, and the exhaust passage to change the flow rates of the aerosolized high-melting-point solution, the inert gas, and diluted aerosolized high-melting-point solution. Then the dilution process 900 proceeds to step 920 to continue the dilution process.

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. A dilution apparatus comprising
a structural body defining
an introductory chamber having a first chamber cross-sectional area,
an expansion chamber extending continuous from the introductory chamber and having a second chamber cross-sectional area that is larger than the first chamber cross-sectional area,
an inert gas port extending into the introductory chamber,
a solution port extending into the introductory chamber,
an exhaust passage having a first passage cross-sectional area fluidly coupled to the expansion chamber, and
a dilution passage having a second passage cross-sectional area fluidly coupled to the expansion chamber,
wherein the first passage cross-sectional area is greater than the second passage cross-sectional area.

2. The apparatus of claim 1, wherein the introductory chamber and the expansion chamber define a continuous multi-chamber volume.

3. The apparatus of claim 2, wherein the expansion chamber extends from an end of the introductory chamber.

4. The apparatus of claim 3, wherein expansion chamber and the introductory chamber are each disposed, concentrically, along a common longitudinal axis of the structural body.

5. The apparatus of claim 1, wherein the structural body defines the inert gas port circumferentially offset from the solution port.

6. The apparatus of claim 5, wherein the structural body defines the inert gas port as longitudinally offset from the solution port.

7. The apparatus of claim 1, wherein the structural body is configured to withstand a temperature of a solution therein up to 700° C.

8. The apparatus of claim 1, wherein
the structural body further defines an exit chamber continuous from the expansion chamber and having a third chamber cross-sectional area that is smaller than the second chamber cross-section area, and
the exhaust passage and the dilution passage extend from the exit chamber.

9. The apparatus of claim 1, wherein
the expansion chamber is configured to produce a diluted aerosol from an aerosolized form of a high-melting-point solution using an inert gas received from the inert gas port, and
the dilution passage is configured to cause an exit of a port of the diluted form of the aerosolized solution.

10. A system comprising
a nebulizer assembly configured to produce an aerosolized form of a high-melting-point solution;
a dilution apparatus configured to produce a diluted aerosol using the aerosolized form of the high-melting-point solution and an inert gas by
introducing a flow of each of the aerosolized form of the high-melting-point solution and a flow of the inert gas into a continuous multi-chamber volume having a progressively larger volume along a longitudinal path of the dilution apparatus to define the diluted aerosol therein, and
channeling a portion of the diluted aerosol of the continuous multi-chamber volume to a dilution passage;
instrumentation, fluidly coupled to the dilution passage, and configured to determine chemical contents of the diluted aerosol.

11. The dilution system of claim 10, wherein the instrumentation comprises an inductively coupled plasma mass spectrometer (ICP-MS) and an inductively coupled plasma optical emission spectrometer (ICP-OES).

12. The dilution system of claim 10, wherein the dilution apparatus channels the diluted aerosol to the instrumentation at a rate of at least 1.0 liter/minute.

13. The dilution system of claim 10, wherein the dilution apparatus channels the diluted aerosol to the instrumentation having a concentration of mass per unit time of electrolyte within the range of 0˜0.15 mg/min.

14. The dilution system of claim 10, wherein the dilution apparatus comprises a structural body defining the multi-chamber volume, the multi-chamber volume comprising an introductory chamber at an entrance of each of the flows and having a first size, and an expansion chamber extending continuously from the introductory chamber and having a second size that is greater than the first size.

15. The dilution system of claim 14, wherein structural body defines an exhaust passage extending from the expansion chamber, the exhaust passage having a size that is substantially greater than a size of the dilution passage.

16. A method of analyzing a molten salt solution, the method comprising
producing an aerosolized form of a high-melting-point solution using a nebulizer assembly;
producing a diluted aerosol from the aerosolized form of the high-melting-point solution using a dilution apparatus, the producing comprising
introducing a flow of each of the aerosolized form of the high-melting-point solution and a flow of the inert gas into a continuous multi-chamber volume having a progressively larger volume along a longitudinal path of each of the through the dilution apparatus to define the diluted aerosol therein, and
channeling a portion of the diluted aerosol of the continuous multi-chamber volume to a dilution passage; and
determining chemical contents of the diluted aerosol using instrumentation fluidly coupled to the dilution passage.

17. The method of claim 16, wherein
the diluted aerosol has a concentration of mass per unit time of electrolyte in the dilution passage, and
the method further includes controlling the concentration of mass per unit time of electrolyte to within a range of 0˜0.15 mg/min by adjusting a flow rate of each of the flows of the aerosolized form of the high-melting-point solution and the inert gas.

18. The method of claim 16, wherein
the diluted aerosol has a flow rate per unit time in the dilution passage, and
the method further includes controlling the flow rate per unit time to at least 1.0 liter/minute by adjusting a flow rate of each of the flows of the aerosolized form of the high-melting-point solution and the inert gas.

19. The method of claim 16, wherein
the continuous multi-chamber volume comprises an introductory chamber and an expansion chamber that is cross-sectionally larger than the introductory chamber, and
the introducing comprises forcing each of the flows of the aerosolized form of the high-melting-point solution and the inert gas sequentially through the introductory chamber, and then the expansion chamber.

20. The method of claim 16, further comprising causing an exit of a balance of the diluted aerosol not channeled through the dilution passage through an exhaust passage, the exhaust passage having a size that is great that than a size of the dilution passage.
